(19) United States
(12) Patent Application Publication
(10) Pub. No.: US 2024/0341376 A1
(43) Pub. Date: Oct. 17, 2024

(54) Auto Darkening Lens Control

(71) Applicant: David Paul Newmwn, Fort Morgan, CO (US)

(72) Inventor: David Paul Newmwn, Fort Morgan, CO (US)

(21) Appl. No.: 18/445,120

(22) Filed: Apr. 15, 2023

(51) Int. Cl. A41D 13/11; G02B 13/00; G09G 3/32

(52) U.S. Cl. CPC A41D 13/11; G02B 13/0055; G09G 3/32; G09G 2320/062

(57) ABSTRACT

This invention pertains to welding helmets with automatic lens darkening. It incorporates a light emitter so positioned to be intentionally activated by the welder for pre-stimulation of the helmet's light detection system, essentially tricking it to darken the lens before striking an arc, thus preventing eye exposure to the initial arc flash.

### BACKGROUND OF THE INVENTION

This invention pertains to welding helmets with automatic lens darkening. In particular it pertains to providing a welder personal control over helmet lens darkening. It incorporates a light emitter so positioned to be intentionally activated by the welder for independently stimulating the helmet's are light detection system, essentially tricking it to darken the lens before striking an arc, thus preventing eye exposure to the initial arc flash, as well as enabling the welder to maintain the lens in a darkened state blocking afterglow as long as desired following a welding sequence.

Traditionally in stick arc welding a welder positions the tip of the welding rod near where an arc is to be struck, then a protective helmet with dark lens is dropped over the face and the arc struck. Very commonly slight shifting of the welding rod tip occurs as the welder nods his or her head to drop the helmet after initially positioning the rod tip. Striking the arc then occurs at the wrong place. The more experienced and skilled the welder is the less problematic it is, but this is always a potential interference to excellent welding.

In attempting to solve this problem modern auto darkening helmets have are light detectors positioned at the front of the helmet for reacting to arc light. An essentially clear auto darkening lens is provided that can be electronically triggered to darken. A welder can look through this lens as the arc is struck and, upon detecting an initial flash, a light detector activates circuitry to darken the lens. There is no need to nod the head to bring down a protective shield.

This attempt at protecting welder eyesight retains a serious problem. The detection Best Available Copy and control systems of modern auto darkening helmets with arc detectors typically require an initial exposure of about forty to seventy microseconds to activate them and cause darkening of the lens. This initial flash, though brief, is also imposed on the welder's eyes. The cumulative affect of a number of these flashes to the welder's eyes can result in at least discomfort if not harm. Ideally, a welding helmet would be in its most protective state throughout the welding sequence, including protection from welding afterglow, as is the case with the older permanently dark helmet lens designs. This is not possible when an initial flash is required for activation to that state.

A different hazard with currently available automatic lens darkening helmets is that in some situations an uninvolved feature or features of the work on which welding is to occur can block the welding arc light, putting the lens arc detectors in shadow and preventing lens darkening. The welder then usually changes head orientation to re-position the helmet detectors, but this is often only after exposure to the arc radiation. Modern helmets usually have at least two arc light detectors and often four or six toward minimizing, yet not eliminating, this problem while inevitably increasing helmet cost and price.

Existing welding systems intending to overcome these auto darkening lens exposure problems assign to special features of a welding apparatus the specific function of establishing the arc. The welder does not do this, but rather begins a technical process which, in various ways, culminates with the equipment itself striking the arc after it initiates lens darkening. These systems do not allow the personal control that skilled practitioners desire, and additionally require welders to have faith in the equipment eliminating risk to their eyesight. Also, current technology does not simultaneously incorporate control of both pre-arc delay and post-arc delay.

Any suspicion that the lens darkening system could fail for any reason is worrisome. Therefore many professional welders, wishing to avoid initial flashes and other potential hazardous exposure, continue using the tried and true but more physically challenging traditional helmets with permanently darkened lenses. These issues are particularly important when training new welders.

### BRIEF SUMMARY OF THE INVENTION

What is needed is an inexpensive, uncomplicated, reassuring, and easy-to-use means giving complete control to a welder for darkening the lens of an auto darkening welding helmet to prevent exposure to arc light radiation, both by darkening the lens before striking an arc, and by maintaining the darkened state as required after a welding sequence is complete.

The present invention positions a light emitter in front of a light detector of the lens of an auto darkening helmet. This emitter is activated by the welder in order to trick the lens into darkening as if an actual arc had been struck whenever the welder so desires, typically before an arc is struck, but also after a welding sequence to maintain the darkened state until welding afterglow fades.

### BRIEF DESCRIPTION OF THE DRAWINGS

1 helmet
2 viewing window
3 auto darkening lens
4 debris shield
5 arc light detector
6 light emitter
7 RF transmitter
8 transmitter button
9 RF signal
10 RF receiver
11 inductive interlink
12 input coil
13 output coil
14 inductive signal
15 IR signal
16 helmet shell
17 welding rod holder

Referring to FIG. 1, helmet 1 viewing window 2 frames auto-darkening lens 3 and debris shield 4, which protects lens 3 and supports light emitter 6. Emitter 6 is shown mounted on clear plastic debris shield 4 in position to stimulate an arc light detector 5 and wired to output coil 13. Output Coil 13 is shown mounted to helmet shell 16.

FIG. 2 shows transmitter 7 with button 8 banded to welding rod holder 17.

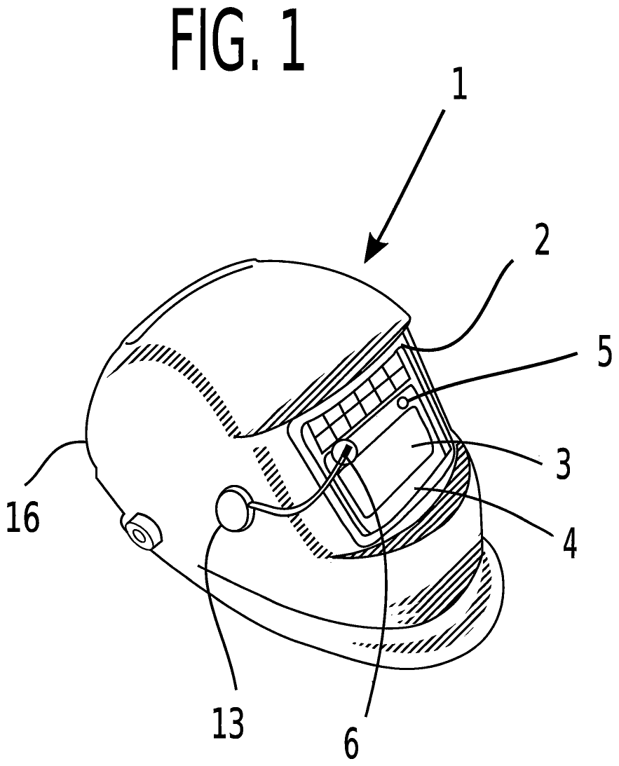

FIG. 3 depicts a typical layout of arc detectors 5 and auto darkening lens 3.

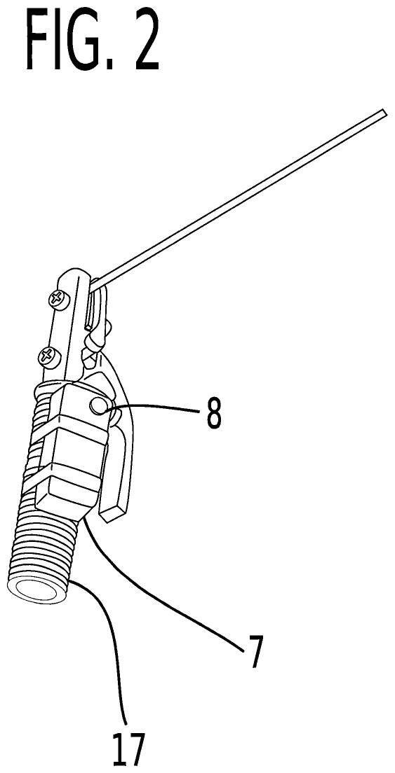

FIG. 4 shows the spatial arrangement of light emitter 6 mounted on clear plastic debris shield 4 such that when the debris shield is in place on a welding helmet and auto darkening lens 3 is also in place, emitter 6 will be in the position shown to stimulate an arc light detector 5.

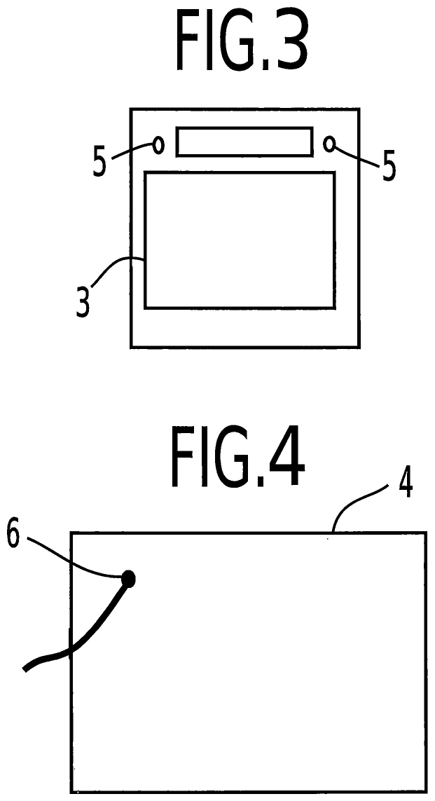

FIG. 5 depicts a side view showing how debris shield 4, light emitter 6, arc light detector 5, and auto darkening lens 3 are spatially related.

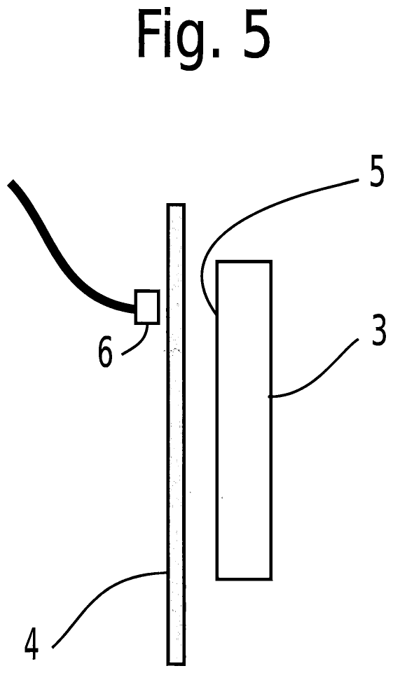

FIG. 6 shows RF receiver 10 mounted to helmet shell 16 and wired to input coil 12 of inductive interlink 11 also mounted to helmet shell 16 opposite output coil 13 of interlink 11.

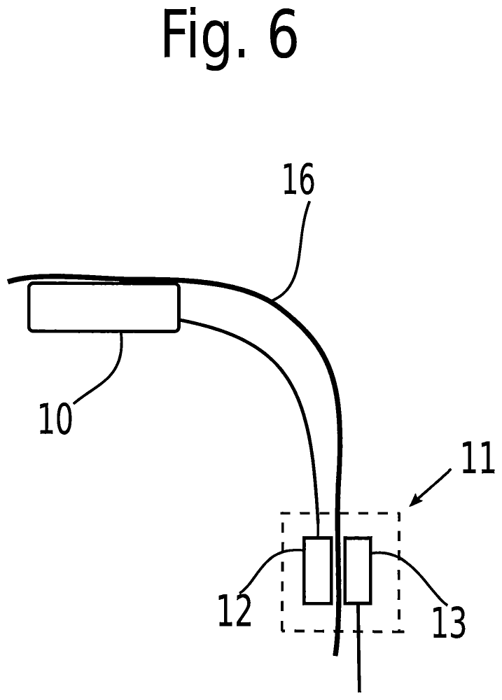

FIG. 7 is a schematic representation of the preferred embodiment of the invention. When button 8 is pushed transmitter 7 sends RF (radio frequency) signal 9 to RF receiver 10 wired to input coil 12 of interlink 11 for sending inductive signal 14 through helmet shell 16 to activate interlink output coil 13. Output coil 13 is wired to emitter 6 which sends IR (infrared) signal 15 to stimulate an arc detector 5 causing it to activate the lens darkening circuitry.

### DETAILED DESCRIPTION OF THE INVENTION

The present invention provides for a welder independent control over an auto darkening helmet lens. The welder not only darkens the lens before an arc is struck, but by doing so verifies every time that the helmet's arc detection and lens darkening system is working. The welder can also control when the lens undarkens after a welding sequence. Such control significantly contributes to a welder's comfort with the welding experience and, by providing the welder personal determination over the lens entire darkening operation, eliminates uneasiness or uncertainty that the automatic darkening technology will provide the protective function expected.

The present invention accomplishes these achievements with a convenient, inexpensive, robust, and novel apparatus. The preferred embodiment comprises a light emitter positioned to stimulate a helmet's arc light detector, a wireless radio frequency receiver to energize the emitter through an inductive interlink, and a wireless radio frequency transmitter mounted on the welding rod holder to energize the receiver.

An automatic darkening helmet lens assembly will have positioned in front of its arc light detecting and darkening components, a protective debris shield. This shield is commonly a clear somewhat flexible plastic plate, and with this invention it can also serve as a convenient structure for positioning the stimulating light emitter which can be attached to its surface with commonly available mounting tape, or be an integral part of it. The RF receiver can be attached to the surface of the helmet with the same ordinary mounting tape, and the two coils of the inductive interlink can also be mounted with this same tape, one on the inside and one on the outside of the helmet shell, opposite each other. The RF transmitter can be constructed for attachment to a standard welding rod holder with convenient elastic bands

The are light detection system of a helmet's automatic darkening lens functions such that the welder's eyes are protected from a wide spectral range of electromagnetic frequencies, from ultra-violet at one end to infrared at the other. Consequently the incorporated helmet light detection systems are necessarily sensitive to light throughout a wide spectral range, and the emitter of the present invention can be chosen from a variety of available designs and specifications. Such emitters can cost less than a dollar, and in the preferred embodiment the stimulating light source is an inexpensive semi-conductor infrared LED. The transmitter and receiver are powered by inexpensive batteries such as 9 volt or AAA batteries. An indicator light is provided to inform the welder when the stimulation system is activated.

The ease of implementing this invention with mounting tape lends itself to upgrading all known auto darkening helmets to performance exceeding the eyesight protection of the highest quality and most expensive helmets presently available or already in the market place.

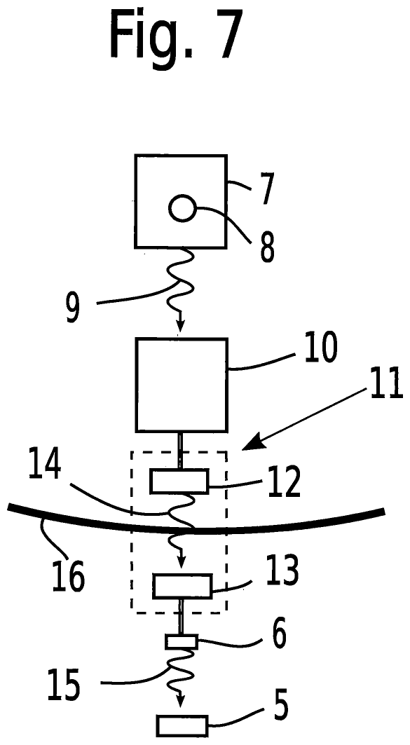

In practice following the preferred embodiment schematic representation of FIG. 7 using a typical auto darkening welding helmet 1 with viewing window 2 auto-darkening lens 3 and debris shield 4 the welder will first view the work through the essentially clear viewing window. Then will position the rod tip for striking an arc. Just before contacting the rod tip to the work, he or

she will push button 8 on transmitter 7 mounted on welding rod holder 17. This action via signal 9 wirelessly instructs RF receiver 10 to energize emitter 6 via signal 14 of interlink 11 through helmet shell 16 to stimulate or “trick” one of the helmets are light detectors 5 via signal 15 to activate the helmet lens darkening circuitry, fully darkening the lens as if an actual arc had been struck. With the welder's eyes now protected by a darkened lens the arc is struck, which is also before any undesirable rod tip movement takes place. At this point the helmet's integral light detection and darkening system can take over for as long as welding arc light continues, but the welder may choose to maintain button push to further assure lens darkening. After a weld bead the welder may hold button 8 down to maintain a darkened lens state while the afterglow fades. With this invention in place the welder's eyes need never be exposed to arc or afterglow light.

As previously described, in the preferred embodiment the detector stimulating light source is a semi-conductor infrared emitter chosen from the many available semi-conductor light emitting diodes. But tiny incandescent bulbs such as “wheat grain” mini bulbs are also satisfactory, and can be powered with such small currents that incandescence is barely visible though fully satisfactory for the operation of this invention.

Similarly, inexpensive mini semi-conductor radio frequency matched transmitter and receiver module pairs for use in the preferred embodiment are commercially available in the range of a few dollars each. These are readily and inexpensively complimented with the appropriate circuitry of this invention to apply power and complete the transmitting and receiving functions of the invention, and can be powered by ordinary batteries such as 9 volt or triple A batteries.

It can be appreciated that this eye protection system for welders is readily and inexpensively fabricated, is easily installed on existing auto darkening helmets, and is perfectly suited to solve the problem of protecting eyesight from an initial arc flash and welding afterglow by providing the welder convenient, reassuring, and complete control over lens darkening. The ease of implementing this invention lends itself to upgrading all known auto darkening helmets to performance exceeding eyesight protection of the highest quality and most expensive helmets presently available or already in the market place.

While this discussion only considers stick arc welding, other applications are envisioned. For example, it is even more desirable for precision TIG (tungsten inert gas) welding where precise positioning of the welding electrode is critical, and even closer gazing upon the work is required. Welding goggles or other vision protective devices that depend upon darkening can also benefit from including this invention. The wireless transmitter can be built into a welding rod holder rather than mounted onto it, or can be placed elsewhere, such as with a foot pedal. It is also understood that there are many applications in which the welding environment allows for external mounting of the Receiver on the helmet, eliminating the need for the inductive link. And while wireless communication between transmitter and receiver is the preferred embodiment, hard wiring instead of wireless communication to the receiver can be chosen as circumstances require.

What is claimed is:

1) A welding helmet auto darkening lens control comprising:
a light emitter positioned for stimulating an arc light detector of the helmet,
a welder activated means to energize said light emitter.

2) A control of claim 1 in which the welder activated means consists of a wireless transmitter receiver pair.

3) A control of claim 1 in which the activated means comprises a wireless transmitter receiver pair and an inductive interlink inductively coupling transmitter receiver pair and light emitter.

4) A welding helmet auto darkening lens control of claim 3 in which inductive coupling is through the welding helmet shell.

5) A welding helmet auto darkening lens control of claim 1 in which the light emitter is an infrared LED.

6) A welding helmet auto darkening lens control comprising:
a light emitter positioned for stimulating an auto darkening helmet lens arc light detector,
a wireless transmitter receiver pair to energize an inductive interlink,
said light emitter energized by said inductive interlink.

7) A method of arc welding with an auto darkening helmet in which lens darkening is controlled by the welder illuminating a lens arc light detector independently of welding arc light.

8) A method of claim 7 in which illuminating the detector is independent of welding apparatus other than the present invention and helmet.
